(19) United States
(12) Patent Application Publication
(10) Pub. No.: US 2005/0097816 A1
(43) Pub. Date: May 12, 2005

(54) Golf course divot repair device and method

(76) Inventors: David L. Elder, Atherton, CA (US); Benjamin A. Elder, Atherton, CA (US)

Correspondence Address: Bruce & McCoy, Ste 750, One Kaiser Plaza, Oakland, CA, 94612, US

(21) Appl. No.: 10/961,766

(22) Filed: Oct. 8, 2004

Related U.S. Application Data
(63) Continuation-in-part of application No. 10/301,771, filed on Nov. 21, 2002, now abandoned.

(51) Int. Cl. A01G 9/02

(52) U.S. Cl. 47/65.8

(57) ABSTRACT

A golf course divot repair device having a hand transportable, pliable, and water-soluble container with a mixture of a specified grass seed and soil mixture disposed in the container in proportions to propagate seed germination which can be placed in a golf divot and activated.

### CROSS REFERENCE TO RELATED APPLICATIONS

This application is a Continuation-In-Part of U.S. patent application Ser. No. 10/301,771 for Disposable Divot Repair Device As A Means for Golf Course Maintenance filed Nov. 21, 2002, now abandoned.

### BACKGROUND OF THE INVENTION

1. Field of the Invention

The present invention relates to a method and apparatus for repairing golf course divots for golf course maintenance which golfers can carry with them and utilize during a round of golf to immediately repair, replace, and rejuvenate divots and other scarred turf areas on golf courses caused during play by golfers.

More particularly, the present invention relates to a hand transportable self-contained golf divot repair device which is small enough that one or more can readily be carried in the pocket of a golfer for placement in divots or scarred areas during a round of play to rejuvenate damaged areas of the golf course.

Still more particularly, the present invention relates to a mixture of grass seed and soil in a soluble container which can be placed in a golf divot or scarred area and activated by dew, rainfall, or irrigation to initiate grass germination in that specific area.

Specifically, the present invention relates to a clean, convenient, and soluable container which holds a mixture of specified grass seed and soil to propagate grass germination which can be placed in a divot and stepped upon to initiate repair of the divot immediately following a golf swing.

Still more specifically, the present invention relates to a golf divot repair device which includes a hand transportable, self-contained, clean, convenient, and biodegradable container which may be colored, or nearly transparent and containing a grass seed and soil mixture which may be colored, to approximate the local grass color so that when the device is deployed, either the container or the contents blend with the grass until the container degrades and the grass seed germinates.

The present invention also includes a new and novel method and process for golf course divot and scarred turf repair which includes specific apparatus which can be carried by a golfer during a round of golf and may be applied to divots or scarred areas for initiation of repair thereof immediately upon completing a golf swing, and without having to first return to a golf cart to obtain repair materials, and relieves golf course maintenance personnel of the need to repair the divots.

2. Description of Prior Art

In the normal act of playing the game of golf, players often damage the primary playing surfaces (the fairways and tee areas) of the golf course by swinging a club into the turf and removing top portions of the grass and underlying soil, thereby creating a divot. In fact, better players may intentionally take a predetermined divot on nearly every shot played other than on the greens. Less experienced golfers will likely take a multitude of different size, configuration, and depth of divots during the playing of their rounds.

Traditional divot repair or replacement methodology involves retrieving the actual remains of the turf torn from the divot and placing the retrieved material into the damaged area. The repair is completed by stepping on the remnant in an effort to ensure that it is firmly in place. However, the majority of divots repaired in this manner are unsuccessful as the roots usually have been separated from the leaves or blades of grass. While traditional divot replacement methodology dictates first using the actual patch of grass and soil to replace the divot, this is not always practical depending on the types of grass and the force/angular dynamics associated with the swing of the golf club. The divot may be of such a size or shape that is not easily repaired, and, in the interest of moving on to the next shot, golfers do not always take time out of their round to retrieve scraps of turf to ensure that each divot is adequately repaired. Many times there may simply just not be sufficient enough remaining cohesive grass and turf material to repair the divot.

A divot repair technique which is similar to traditional divot replacement methodology described supra is identified in the numerous patents listed in the prior pending patent application of which this is a continuation-in-part. Those patents disclose a biodegradable turf anchor stake or like device that is driven through pieces of retrieved grass and soil material when it is replaced in divots to keep the returned material affixed in place. However, as with traditional methodology, this method does not rejuvenate and regrow grass since there is no presence of new seedlings nor additional soil material to fill the divot. In addition, this method of replacing divots is time-consuming and inconvenient (providing little additional advantage over replacing turf material without this device) and summarily is not likely to be practiced nor strictly enforced on the golf course.

A recent and more sophisticated divot repair methodology comprises filling the cavity of the divot to the level of the underlying soil with a sand and seed mixture extracted from a dispenser, typically a large canister. These dispensers are usually provided by the golf course and located at the tee areas and sometimes along the fairways. Alternatively and concurrently, smaller jar-sized seed/soil mixture dispensers are supplied to the golf carts utilized to transport the golfers. These dispensers can either be canisters holding several pounds of divot mix located primarily at tee areas or smaller-sized containers which can be carried from the cart to the divot site for dispensing a variable small-sized portion thereof. The larger containers may weigh upwards of ten pounds when full of sand and seed mixture while the smaller containers do not carry enough sand and seed mixture for a full round of golf which may require that numerous containers be carried on the cart or constant refills. It will be shown, but it should be obvious, that the national average of over 20 per cent of golfers who carry their clubs and walk the golf course cannot carry the additional weight and volume of ajar-sized canister containing a grass seed and sand mixture.

Most golf courses today encourage golfers to practice the more sophisticated repair methodology of the prior art of applying a sand and seed mixture to the divot. However, due to distance factors and inconvenience, players often will not make the effort to go back and forth from a freshly made fairway divot to their respective golf carts for sand/seed mix containers, back to the divot for repair, and then back to the golf cart to replace the sand/seed mix container before proceeding on with the golf round. This same inconvenience applies at tee areas when there is no container of sand/seed mix alongside the box. Further, certain tee box sand/seed dispensers only present another inconvenient and inconsistent divot replacement method that usually involves a wooden box full of sand seed mix and a scoop. The golfer must first guess the amount of mix required to fill the divot and use the scoop to transport the dirty, spillable, extracted amount of sand/seed mix from the box to the divot. He or she must return to the box, if necessary, for additional material and then return yet again to replace the scoop back into the box. If there is no scoop for some reason, it is not likely that the golfer will carry the dirty mixture by hand and the divot will go unrepaired. Unfortunately, this more sophisticated repair methodology of the prior art of applying a sand and seed mixture to the divot is a cumbersome turf repair system that involves numerous time-consuming steps.

The containers used to transport the sand/seed mixtures around the golf course come in many shapes, sizes, and designs as shown in numerous U.S. patents such as those listed in the prior pending patent application of which this is a continuation-in-part. Some of these devices are so large that they are more practical for use by the golf course grounds keepers and maintenance personnel than by individual golfers and the use of which, in any event, would cause delay and extra effort by golfers which would hold up play of the following golfers.

Some of the problems and inefficiencies that are inherent in the existing repair or replacement alternatives, and in the techniques and devices and apparatus of the patents associated with the known prior art for divot repair, are that many golfers simply do not replace divots because there is not a convenient method within immediate reach of the golfer while he is out of the cart or walking on the course, and has addressed and swung at the ball, with which to do so. At some courses, divot replacement techniques are not taught, nor strictly followed, nor enforced by golf course rules enforcement personnel. Thus, golf course maintenance personnel are required to spend time, valuable resources, and money to properly repair divots and turf scars left by the golfers, all of which can be avoided if there were a more convenient method for divot repair or replacement which could be employed by each golfer after each golf swing.

The average golfer who walks the course (for example, a golfer that carries a set of golf clubs as opposed to being transported using a gas or electric powered golf cart) is at a serious disadvantage in terms of convenient divot repair or replacement options. This is because a golfer that walks the course cannot carry a container that is full of sand/seed mix of a reasonable size to be easily and cleanly utilized. Therefore, walking golfers are forced to practice the only divot replacement alternative that is available which involves retrieving what remains of the actual patch of grass and soil to replace the divot. As mentioned previously, this is not always practical due to time and turf material retrieval constraints. It does not happen often, and the replaced divots will most often not grow new grass.

The exposed sand/seed mix of the prior art, when it is poured into a divot from a sand/seed container, is subject to the wind which can scatter the replacement mix after it is placed in the divot. The replacement mix is unprotected from the effects of mowing and other elements that will scatter the sand and/or seed out of the divot; especially if it is not first watered. Further, the exposed seed in the sand seed mix poured into a divot from a sand seed container may be consumed by wildlife. The mix is exposed to erosion by concentrated irrigation or heavy rain.

While the mixture is inside the sand/seed containers which are carried on the carts, the sand/seed mix will settle out and separate due to the jostling of the containers during movement of the carts with the lighter seed rising to the top thereby reducing the mix consistency and thus the effectiveness of the mixture. Further, the seed may prematurely germinate in the containers. Some golfers do not sufficiently fill their divots by improperly measuring the amount of seed/sand mixture required to fill the divot. The additional equipment which is required to refill canisters may be inconvenient to transport, time consuming to manipulate, and expensive to acquire.

Another method that is referred to as a convenient method for the germination of various plants (not in the context of divot replacement) is with the use of a seedling or germination median commonly known as seed tapes. These are strips of biodegradable paper and adhesives, seeds, and fertilizers, which are either buried in or placed on the ground with the expectation that the seedlings will germinate and grow into new plants. Patents that incorporate seed tape technology are listed in the aforementioned prior pending patent application and distinguished therein.

While seed tapes may be useful in many agricultural contexts, including home gardening and commercial farming, they are not designed to accommodate divot repair on the golf course for numerous reasons including: they are generally strips or sheets of biodegradable paper that lack the volume of material necessary to sufficiently fill a divot; they are designed to be buried in or affixed to the ground or may otherwise be blown or washed away; they are not designed for convenient transport or application, specifically around a golf course. None of the listed patents mention the use of seed tapes for divot repair and turf maintenance at a golf course. As such, seed tapes do not represent a convenient nor practical methodology for divot repair.

Other patents with seed tape type technology propose having the seed tapes, or possibly just seed and fertilizer, in biodegradable containers. These containers can be packets, pots, bags, or other planting devices that are usually buried in the ground to grow different kinds of plants. These devices are useful for gardening and commercial farming, but burial of a device on a golf course during a round of golf is impracticable. These devices are not sealed nor airtight nor are they soluble or expected to dissolve rapidly in the presence of water. Representative patents are listed in the aforementioned patent application.

Still another set of patents listed in the aforementioned prior pending application disclose turf mat technology and are distinguished therein. None of this technology is adaptable to practical golf course divot repair during play by the golfers due to the quantities of materials and sizes of the containers and turf mats involved. The patents do not mention nor are they adaptable to golf divot repair, and they do not provide a convenient method to repair divots on a golf course. Turf mats are unrelated to golf course divot repair because they are primarily used for large-scale agricultural projects where turf or plant seeds are placed over a large area of land.

Therefore, it is obvious that the use of grass seed and sand mixtures which are dispensable from containers by pouring or tool extraction, for the purpose of repairing golf course divots, is known in the prior art. However, despite the numerous designs, structures, and forms of apparatus disclosed by and utilized in the prior art, which have been developed for the accomplishment of the specific objectives, purposes, and requirements of golf course grass seed propagation, the devices, machines, apparatus, and methods which have been heretofore devised and utilized to accomplish this goal consist basically of familiar, expected, and obvious configurations, combinations, and arrangements of well-known apparatus which do not lend themselves to fast, clean, readily transportable, and immediate golf course divot repair as is contemplated by the present invention. This has become apparent from the previous consideration of the closest-known and relevant prior art devices and methods disclosed by the listed patents.

The golf course divot repair device and method contemplated according to the present invention departs substantially from the conventional concepts and designs taught and used by the prior art, and in doing so, provides an apparatus and method primarily developed for the purpose of overcoming the problems described above, but it accomplishes the result in a different and improved manner for effecting golf course divot repairs more easily, conveniently, cleanly, accurately, faster, and economically.

### SUMMARY OF THE INVENTION

In view of the foregoing known, obvious, and described disadvantages inherent in the known types of golf course divot repair devices, apparatus, and methods presently existing in the prior art, the present invention provides a new method, apparatus, and construction of a device for golf course damage and divot repair wherein the same can be utilized by individual golfers to repair golf course divots conveniently, cleanly, and quickly during play immediately after a golf swing.

The general purpose construction of the present invention, which will be described hereafter in greater detail, has been designed to provide a new and improved golf course divot repair apparatus and method which has many of the advantages of the prior aforementioned art as described above. It is comprised of many novel features and advantages and performs the functions that result in a new golf course divot repair device and method which are not anticipated, rendered obvious, suggested, or even implied by any of the prior art of golf course divot repair, and heretofore known either alone or in any combination thereof.

The present invention is a golf course divot repair device comprising a hand transportable, pliable, and water-soluble container which is small enough that one or more can be carried in a clothing pocket of a golfer. A mixture of a specified grass seed and soil is disposed in the container. The device can be placed in a divot whereby the application of water will dissolve the container and propagate seed germination.

The present invention also includes the method for divot repair on a golf course. The steps comprise providing a mixture of a specified grass seed and soil disposed in a hand transportable, pliable, and water-soluble container device in preferential proportions to propagate seed germination. The device is of a size which can be carried in a clothing pocket of a golfer. A multiple of the devices are carried when a golfer is playing a round of golf. When a divot is created or located on the golf course, one or more of the devices is placed in the divot. The device(s) can then be stepped on to press it into the divot to conform to the shape of the divot and to level the playing surface.

The more important features of the invention have been broadly outlined in the preceding summary of the invention in order that the detailed description thereof which follows may be better understood and in order that the present contribution to an improvement in the art may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a golf course divot repair device which is readily transported in multiple, small, pre-measured units, which may be linked or singular, one or more of which can be easily selected and conveniently placed in a golf divot or scarred turf area whereby, dew, rainfall, or irrigation will initiate regrowing grass at the divot site.

It is another object of the present invention to provide an inexpensive, self-contained golf course divot repair device of grass seed, sand, and/or soil in a disposable container which is clean and can be conveniently carried by a golfer in the pocket of a golfer's clothing and be removed and deposited and fitted by the golfer in a golf divot or scarred area on a golf course immediately following a golf swing during a round of golf.

It is a further object of the present invention to provide a golf course divot repair device containing a mixture of grass seed and soil disposed in a container, the seed and soil mixture being in proportions to propagate seed germination when placed in a golf divot or scarred area, and activated by dew, rainfall, or irrigation for divot repair.

It is still another object of the present invention to provide a golf course divot repair device for containing the grass seed and soil mixture in a soluble and flexible container which can be forced to conform to the divot depression by stepping on it to press it into a golf divot or scarred area to await germination by the application of water.

It is yet a further object of the present invention to provide a golf course divot repair device having a soluble, colored, or transparent container, and possibly colored contents, which will absorb heat and blend with the surrounding turf to preserve the natural beauty of the golf course when deposited in a divot or scarred area, and activated by water, and which will respond to the environment and dissolve in a timely manner into the ground without harmful litter, waste, or residue.

It is yet another object of the present invention to provide a golf course divot repair device having a grass seed and soil mixture which is bio-engineered to be environmentally compatible with the golf course turf and includes the grass seed and soil to match the turf of the particular course on which the device is to be deployed; the mixture being disposed in a container made of a material which can be transparent and is flexible and biodegradable, will hold the contents in place, and promote a self-sustaining grass germination process.

And it is still a further object of the present invention to provide a convenient, clean, quick, and inexpensive method of immediate divot repair on a golf course which is employed by the golfer immediately after a golf swing as opposed to later repairs if and when found by golf course maintenance personnel after the golf rounds are done for the day.

Other objects and advantages of the present invention will become apparent when the method and apparatus of the present invention are considered in conjunction with the accompanying drawings.

### DESCRIPTION OF THE DRAWINGS

The invention is illustrated in the accompanying drawings but not limited by reference to the particular embodiments shown therein of which:

FIG. 1 is a perspective view of a preferred embodiment of the present invention;

FIG. 2 is a top plan view thereof; and

FIG. 3 is a side elevation thereof.

### DESCRIPTION OF THE PREFERRED EMBODIMENT

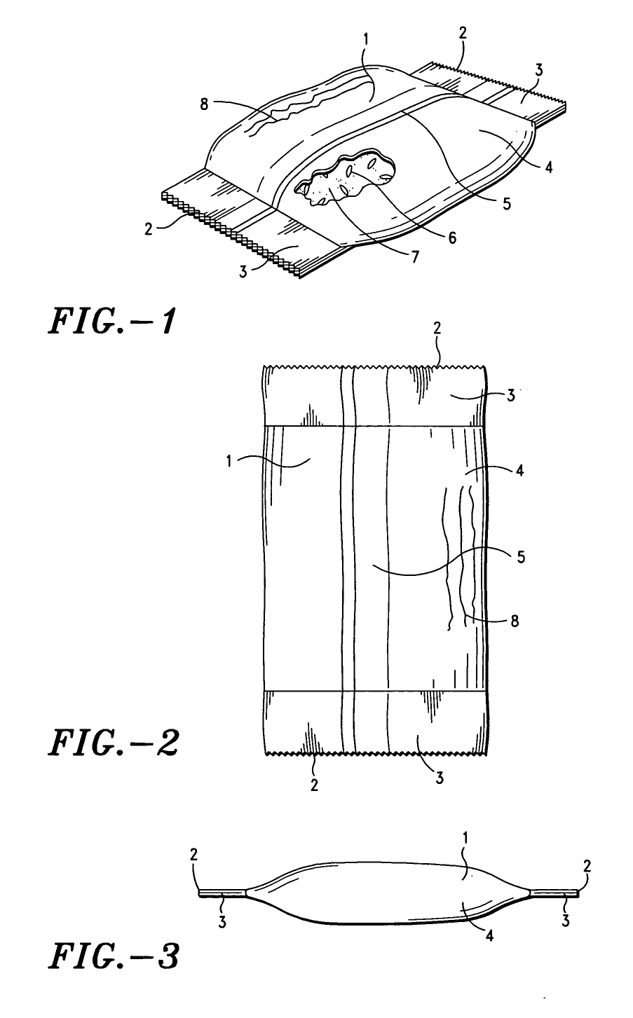

Reference is made to the drawings for a description of the preferred embodiment of the present invention wherein like reference numbers represent like elements on corresponding views. FIG. 1 shows the golf course divot repair device of the present invention which is comprised in part of a hand transportable, pliable, and water soluble container in the form of a vacuum packed or airtight packet which contains a mixture of grass seed and soil.

The containers can be separately constructed or a multiple of these containers can be formed and secured together during manufacture with detachable connections whereby one or more of the packets can be selected and separated by the golfer for use. The repair device is hand transportable meaning that it is of a small enough size whereby it can be carried in a clothing pocket of a golfer on the course during play. The optimum size is between two and three inches (5-7.5 cm) wide, two and four inches (5-10 cm) long, and one-fourth to one-half inches (0.5-1.0 cm) in thickness. Obviously larger sizes would eliminate the need to use multiple packets and most likely would be cheaper to produce. A preferred shape is rectangular which fits well into a normal divot yet the device can be produced in a variety of other sizes and shapes, such as oblong, square, or tubular, all of which will serve the purpose. It is preferably air-tight with vacuum-packed contents to compact the contents and inhibit shifting and separation of the contents prior to use and to promote cleanliness by eliminating leakage or spillage.

The packets can be carried in a golf bag, on a golf cart, in a convenient carrier, or located in sheltered boxes around the golf course. One or more packets can be carried by the golfer between the golf cart and location of his ball during play so that upon the completion of his swing, one or more of the containers may be dropped in the divot and pressed into position for subsequent activation. The golfer may even drop the packet on the ground before his swing if he does not want to be even slightly encumbered during his swing, and then move the packet into the divot with his club head or foot after his swing. The golfer can thus repair the divot without having to return to the golf cart or go over and reach into his golf bag after his swing to retrieve one of the devices as is necessary with the prior art.

The container of the present invention is water-soluble so that it can be left by the golfer for activation after he has placed the repair device in a divot or scarred area. The golfer would normally step on the container to press the contents into the divot or scarred area depression in the turf. The subsequent application of water by dew formation, rainfall, or irrigation will activate the device. The container, however, is sufficiently durable that it will withstand the forces, stress, and abuse associated with being transported in a golfer's clothing pocket or golf bag alone or in multiples thereof.

The container is biodegradable with water so that, after it is deployed by the golfer, it will ultimately disappear. The material could be thin sheets of paper material composed of such ingredients as chlorine and acid-free fibers, vegetables, hemp, and other natural elements or water soluble plastic films. The important characteristic of the container outer shell is that it will rapidly dissolve or decompose when exposed to moisture, sunlight, abrasion, and other conditions of the elements, or the golf course environment, yet it is designed to be sufficiently durable and flexible with adequate bursting strength so as not to rupture before being placed in a divot and pressed thereinto. A container made of these materials will offer a cohesive and consistent patch to the playing surface with superior moisture retention, heat absorption, and seed and soil cohesion to keep the materials from blowing away and to hasten germination of the mixture contained in the packet.

In the preferred embodiment of the invention, however, the container is made of water-soluble materials such as polyvinyl alcohol (PVA or PVOH) films which are plastic in nature and come in a wide variety of compositions, depending upon the desired use, and are highly adaptable to mass production techniques. The water-soluble packets have all of the beneficial attributes of the paper material containers described above but are more desirable. They are more environmentally friendly as they dissolve and disappear more readily; they are susceptible to high technology production processes for producing a wide variety of sizes and shapes of packet designs; they are relatively inexpensive to manufacture; and they produce a tough clean package.

The device can be colored for camouflage. Either the container can be produced in a variety of colors or it can be transparent, clear, or translucent, and the contents can be dyed; primarily various shades of green or in a camouflage pattern comprised of dark green, tan, and dark brown, for desert or winter use to blend with the grass color of the particular golf course on which the repair device is to be deployed. The color can be in general approximate to the particular grass color of the course and need not be specific thereto fall within the concept of the invention. If the container material is clear or translucent, the seed/soil mixture may be colored. The colors can be selected for the locale, grass color, and the particular climate condition in which they are to be used. Printed colors on the container shell will be composed of nontoxic, soy-based dies or other biodegradable ink supplements and tinted in an appropriate fashion to capture warmth and to assist in camouflaging the device.

The packet can be produced in a multiple of manufacturing configurations, including vertical fill, pillow pack, and other configurations. In one form the container can have two sealed edges that will be fused together in manufacturing possibly by electronic fusion process and mechanical securement process or possibly by a biodegradable adhesive. Such an adhesive would have the same biodegradable characteristics as the other materials in the packet. If the container is made of a PVOH film, in its simplest embodiment it can be formed in a tube which is sequentially filled and cross sealed into individual packets which are then separated into multiples or singles.

The device container can include golf related information printed on the packet, such as identifiable logos, a contents listing, advertising, and instructions describing divot repair in general, particular instructions on how to deploy and position the device of the present invention, and, if desired, other information pertaining to the particular golf course on which the device is to be used.

The repair device carries a mixture of a specified grass seed and soil disposed in the container or packet in proportions to propagate seed germination. The specified grass seed would preferably match the grass of the local golf course on which it was to be deployed. The grass seed can be a multiple of types including but not limited to: Kentucky Bluegrasses, Ryegrasses, Fescues, Bentgrasses, Zoysiagrasses, and Bermuda Grasses. The type of grass seed used will depend upon what type is used by each individual golf course

The included soil would likewise be of the topical local soil and of a composition to promote seed germination. If the soil particulate mixture has a sand component, the sand will have been screened for consistency and kiln dried to eliminate any foreign and unwanted plant material. The sand or topical local soil mixture may be enhanced by the addition of environmentally sound fertilizers, conditioners, weed suppressants, pesticides, amendments, or other materials to facilitate the rapid germination of grass and rejuvenation of the damaged turf. The grass seed and particulate soil mixture may be dyed the color of the local or surrounding environment so that the mixture will further blend therewith when it is deployed on the course to await the application of water and after it is released.

The process of using the disposable divot repair device of the present invention, which includes a water-soluble container containing seed and soil, to repair, replace, and rejuvenate divots and scarred turf areas of the golf course, is convenient for golfers to employ immediately following a golf swing. It involves only a few, fast, simple steps which eliminate the costly need for golf course maintenance personnel to do the job subsequently. Detailed instructions for repairing a divot using the packet can be listed step-by-step on the outer shell of the packet but are naturally self intuitive and can be explained by the golf course pro or maintenance people prior to the golfer commencing a round of golf carrying a supply of the repair devices.

To effect the repair, first one packet, or more if the divot or scarred area is large, is selected from the supply of packets. If the packets have been manufactured in multiples, the desired number is separated from the rest by tearing along a perforated or previously weakened connection between two packets. The separated or individual packets are placed into the divot or on top of the scarred turf area. The golfer steps on the packet(s) to press it into the shape of the divot. The mixture is thereby disposed adjacent to the underlying soil to enhance seed germination upon activation. The water-soluble container is deformed, left in the divot, decomposes and dissolves when soaked by dew, rainfall, or irrigation, and the grass seed germinates and new grass grows under the influence of the natural elements.

Thus, the present invention includes the method of divot repair on a golf course which comprises providing a mixture of specified grass seed and soil in hand-transportable, pliable, and water-soluble biodegradable containers in specified proportions to propagate seed germination. The container is of a small enough size which can be carried in a clothing pocket of the golfer. A multiple of the devices are carried by a golfer playing a round a golf, and when a divot is created, located, or selected on the golf course, one or more of the packets are placed in the divot. The golfer then steps on the container to press the container and the contents thereof into the form of the divot. The method also includes the further step of watering naturally or by irrigation the contents of the device disposed in the divot to initiate seed germination.

From the description of the apparatus and the method set forth above, a number of advantages of the golf course divot repair device are made evident. The container is small and hand transportable whereby it can be carried in a golfer's pocket or golf bag for convenience and quickly and cleanly used. The supply of containers is convenient because each unit is small and a multiple thereof can be carried individually or as a single unit and the golfer may select the number he or she needs for quick and easy divot repair. The packets are sufficiently durable to withstand handling and moderate abuse associated with being carried in a golfer's pocket or golf bag and yet are easily deployed whereby they can be quickly made ready for subsequent turf regeneration by water. The container will hold the seed/soil mixture in a divot despite exposure to sunlight, wind, and the effects of the natural elements and conditions.

The present invention offers the further convenience that the container is such that the golfer has the option to tear open the container and simply poor the seed and soil mixture into the divot. The water soluble packet is composed of a transparent, translucent, or camouflaged biodegradable paper or PVOH plastic or other natural elements which blend with the grass and which eliminate the aesthetically displeasing white spot marks that occur on golf courses as a result of pouring a sand-based seed mixture into the divots. The material of the container of the present invention starts to dissolve upon contact with water and, once wetted, still holds moisture to hasten germination and manipulates the climate by absorbing heat.

The present invention eliminates the necessity of having a golf cart or a pull cart to transport large heavy jugs or canisters of seed mix for divot repair or the need to provide seed boxes and containers at the tees. Supplies of the packets can be positioned in the pro shops for dispensation prior to the commencement of a round of golf or at the tees for pickup during a round of golf. The golf course divot repair device can be provided with many different types of grass seeds and soil compositions to match the particular course for which it is to be employed. The packets can be provided in different color choices, and the soluble containers will eventually dissolve in the event a scrap or piece of the container escapes from the divot and will not be seen due to the transparency or matching coloring thereof and will be also be shredded if it is exposed to mowing machinery.

The devices can be made available to golf courses in many different sizes to accommodate each golfers specific turf repair needs. The containers can be constructed in such a way that mirror the average size and shape in divots being of small rectangular shaped construction. The biodegradable packets will be responsive to earth sciences, employ environmentally safe technologies in the production and manufacturing, including bio-engineering of the packages so that upon contact with water, they will dissolve and decompose therefore being entirely biodegradable. The package and its contents will not contain any harmful fertilizers, acids, chlorine or toxins that would harm the ecosystem or local wildlife in any way.

The biodegradable golf course repair device of the present invention is an inexpensive, clean, and convenient way to handle an otherwise dirty mixture of sand, soil, and grass seed in convenient, consistent, pre-measured amounts. It is an effective enhancement or alternative to existing turf repair and maintenance programs which permits the golfer to immediately repair turf damage after a golf swing rather than later by course maintenance personnel after the divot underlying soil has dried out. In addition to the design of the device being clean and aesthetically pleasing, the invention is aimed at helping golf course superintendents solve the divot repair dilemma by saving valuable staff time and money on turf repair and maintenance.

Thus, it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

1. A golf course divot repair device comprising
a hand transportable, pliable, and water-soluble container which is small enough that it can be carried in a clothing pocket of a golfer, and
a mixture of a specified grass seed and soil disposed in said container in proportions to propagate seed germination.

2. The golf course divot repair device of claim 1 wherein said container is made of a polyvinyl alcohol film.

3. The golf course divot repair device of claim 1 wherein a multiple of said divot repair device containers are secured together with detachable connections.

4. The golf course divot repair device of claim 1 wherein said container is colored to blend with the grass color of the particular golf course on which the device is to be deployed.

5. The golf course divot repair device of claim 1 wherein said container is at least translucent and said mixture is dyed to approximately match the grass color of the particular golf course on which the device is to be deployed.

6. The golf course divot repair device of claim 1 wherein said mixture includes one or more additives selected from fertilizers, soil conditioners, pesticides, and amendments.

7. The golf course divot repair device of claim 1 including golf related information printed on said container pertaining at least to instructions for the activation and use of said device.

8. A golf course divot repair device comprising
a hand transportable, pliable, and water-soluble container made of a polyvinyl alcohol film and of a size which can be carried in a clothing pocket of a golfer, said device being colored to blend with the grass color of the particular golf course on which the device is to be deployed and having instructions for use printed thereon, and
a mixture of a specified grass seed and soil including one or more additives selected from fertilizers, soil conditioners, pesticides, and amendments disposed in said container in proportions to propagate seed germination, said mixture being dyed to approximately match the grass color of the particular golf course on which the device is to be deployed.

9. The golf course divot repair device of claim 8 wherein a multiple of said divot repair device containers are secured together with detachable connections.

10. A method for divot repair on a golf course comprising
providing a mixture of a specified grass seed and soil disposed in a hand transportable, pliable, and water-soluble container device in preferential proportions to propagate seed germination, said device being of the size which can be carried in a clothing pocket of a golfer,
providing a multiple of said devices to a golfer when he or she is playing a round of golf, and when a divot is created or located on said golf course,
placing one or more of said devices in said divot, and
stepping on said device to press the device to conform to the form of said divot.

11. The method of claim 10 including
said container being comprised of a polyvinyl alcohol film, and
watering said device disposed in said divot by dew, rainfall, or irrigation to dissolve said container and germinate said seeds.

12. The method of claim 10 wherein
said device is colored to blend with the grass color of the particular golf course on which it is to be deployed.
